(19) United States
(12) Patent Application Publication
(10) Pub. No.: US 2026/0205695 A1
(43) Pub. Date: Jul. 16, 2026

(54) IMAGE CAPTURING APPARATUS, CONTROL METHOD OF IMAGE CAPTURING APPARATUS, AND STORAGE MEDIUM

(71) Applicant: CANON KABUSHIKI KAISHA, Tokyo (JP)

(72) Inventor: MASAKI YAMAUCHI, Tokyo (JP)

(21) Appl. No.: 19/421,451

(22) Filed: Dec. 16, 2025

(30) Foreign Application Priority Data
Jan. 14, 2025 (JP) 2025-004678

(51) Int. Cl. H04N 23/68; H04N 23/69

(52) U.S. Cl. CPC H04N 23/685; H04N 23/6811; H04N 23/69

(57) ABSTRACT

An image capturing apparatus includes at least one memory storing instructions; and at least one processor executing the stored instructions causing the image capturing apparatus to: detect a change in position of a subject within an angle of view; cause a drive target to move from a reference position using a drive apparatus, thereby controlling an angle of view of an image obtained by using an image capturing element; determine an aspect ratio of an output region that is output as an image within an image capturing region of the image capturing element; determine, within the image capturing region, a position of the output region having the determined aspect ratio in accordance with the change; and determine a movement amount of the drive target from the reference position based on the change, an aspect ratio of the image capturing region, and the aspect ratio of the output region.

### BACKGROUND

### Field of the Technology

The present disclosure relates to an image capturing apparatus, a control method of the image capturing apparatus, and a storage medium.

### Description of the Related Art

Electronic blur correction is known as a technique for correcting blur in image capturing by an image capturing apparatus, the blur being a change in position of a subject within an angle of view, wherein the blur is corrected by outputting, as an image, a region extracted in accordance with the blur from an image capturing region of an image capturing element. In addition, as a technique for correcting blur, optical blur correction is also known in which blur is corrected by causing a drive target to be driven in accordance with the blur. Japanese Patent Laid-Open No. 2016-173411 discloses a method in which blur is corrected by sharing a correction amount between an electronic blur correction method and an optical blur correction method in accordance with the magnitude of blur applied to an image capturing apparatus.

In this context, a relationship between the image capturing region and the output region may differ in accordance with image capturing, for example, in a case in which a relationship between an aspect ratio of an image capturing region of an image capturing element and an aspect ratio of an output region of an image extracted from the image capturing region in electronic blur correction differs according to image capturing, and the like. In this case, when optical blur correction is performed uniformly regardless of the relationship between the image capturing region and the output region, an effect of correction may become small depending on image capturing.

### SUMMARY

The present disclosure is directed to realize optical correction of a position change of a subject within an angle of view in consideration of a relationship between an image capturing region and a region output as an image.

An image capturing apparatus according to the present disclosure includes: at least one memory storing instructions; and at least one processor executing the stored instructions causing the image capturing apparatus to: detect a change in position of a subject within an angle of view; control an angle of view of an image obtained by using an image capturing element by moving a drive target from a reference position via a drive apparatus; determine an aspect ratio of an output region that is output as an image within an image capturing region of the image capturing element; determine a position of the output region of the determined aspect ratio within the image capturing region in accordance with the change; and determine a movement amount of the drive target from the reference position based on the change, an aspect ratio of the image capturing region, and the aspect ratio of the output region.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of an image capturing apparatus.

FIG. 2 is a schematic diagram of a shift lens as viewed from the optical axis direction.

FIG. 3 is a diagram showing a relationship between a movable range of a lens in the horizontal direction and a movable range of a lens in the vertical direction.

FIGS. 4A and 4C are diagrams showing a relationship between an image capturing region and a crop image.

FIG. 5 is a flowchart diagram showing a flow of correction amount determination processing.

FIG. 6 is a flowchart diagram showing a flow of position determination processing.

FIG. 7 is a flowchart diagram showing a flow of position determination processing.

FIGS. 8A and 8C are diagrams showing a movable range of a lens determined in position determination processing.

FIGS. 9A and 9C are diagrams showing a relationship, determined in the position determination processing, between a movable range of the lens in the horizontal direction and a movable range of the lens in the vertical direction.

FIG. 10 is an overall configuration diagram of an image capturing apparatus in a Second Embodiment.

FIGS. 11A and 11B are schematic diagrams of a shift-type image capturing element as viewed from the optical axis direction.

FIG. 12 is a diagram showing a relationship between a movable range of an image capturing element in the vertical direction and a range in which the image capturing element is rotatable.

FIG. 13 is a flowchart diagram showing a flow of correction amount determination processing.

FIG. 14 is a flowchart diagram showing a flow of position determination processing.

FIG. 15 is a flowchart diagram showing a flow of position determination processing.

FIGS. 16A and 16C are diagrams showing a movable range of an image capturing element determined in position determination processing.

### DESCRIPTION OF THE EMBODIMENTS

### First Embodiment

Hereinafter, embodiments of the present disclosure are explained with reference to the drawings.

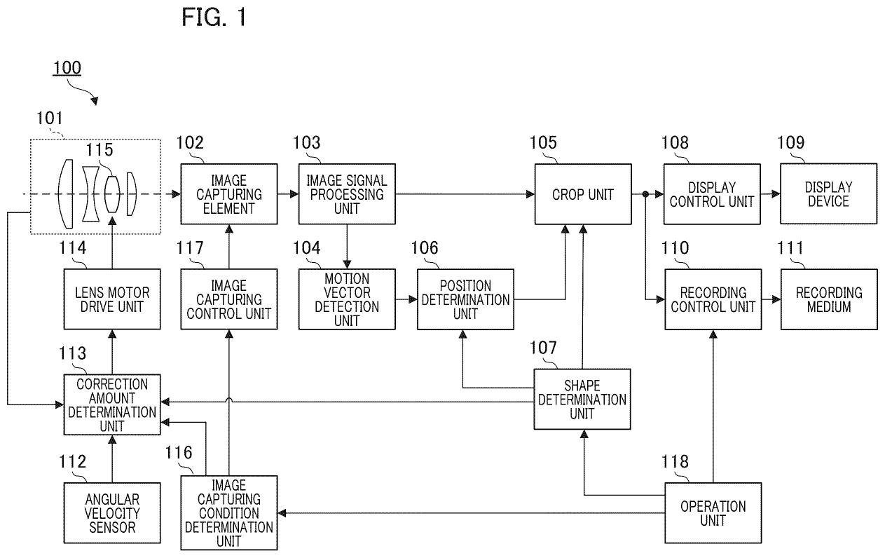

FIG. 1 is an overall configuration diagram of an image capturing apparatus 100.

The image capturing apparatus 100 is provided with an image capturing lens 101, an image capturing element 102, an image signal processing unit 103, a motion vector detection unit 104, a crop unit 105, a position determination unit 106, a shape determination unit 107, a display control unit 108, and a display device 109. In addition, the image capturing apparatus 100 is provided with a recording control unit 110, a recording medium 111, an angular velocity sensor 112, a correction amount determination unit 113, a lens motor drive unit 114, an image capturing condition determination unit 116, an image capturing control unit 117, and an operation unit 118.

In addition, the image capturing apparatus 100 has a CPU (Central Processing Unit) (not shown) and a memory (not shown). In the present embodiment, various functions described below with respect to the image capturing apparatus 100 are realized by the CPU of the image capturing apparatus 100 executing a program.

The image capturing lens 101 is configured by a plurality of optical members, and the image capturing lens 101 performs operations such as zooming and focusing and forms a subject image on the image capturing element 102. For the image capturing lens 101, a focal length is determined in accordance with a zoom operation, and the image capturing lens 101 outputs information indicating the determined focal length to the correction amount determination unit 113. In addition, the image capturing lens 101 has a shift lens 115.

The shift lens 115 is a part of a lens group that configures the image capturing lens 101. The shift lens 115 optically corrects blur of the image capturing apparatus 100 by deflecting the optical axis by translating in a direction orthogonal to the optical axis. By driving the shift lens 115 in accordance with blur of the image capturing apparatus 100, an image in which blur of a subject on the image capturing plane caused by blur of the image capturing apparatus 100 is corrected is formed on the image capturing element 102.

The image capturing lens 101 may be a fixed lens that is integral to the image capturing apparatus 100, or may be an interchangeable lens that is attachable to and detachable from the image capturing apparatus 100.

The image capturing element 102 converts a subject image that has been exposed for a predetermined time based on a shutter speed into an electric signal. The image capturing element 102 may be, for example, a CMOS image sensor or the like. It should be noted that an image obtained via image capturing by the image capturing element 102 is sometimes referred to below as a captured image.

The image signal processing unit 103 converts the electric signal output by the image capturing element 102 into an image signal, and the image signal processing unit 103 outputs the converted image signal to the motion vector detection unit 104 and the crop unit 105.

As an example of a detection unit, the motion vector detection unit 104 detects, as a motion vector, residual blur of video that could not be completely corrected by the shift lens 115, based on the image signal acquired from the image signal processing unit 103. The motion vector detection unit 104 outputs vector information indicating the detected motion vector to the position determination unit 106. A detection method of a motion vector by the motion vector detection unit 104 may be, for example, a known method such as a matching method in which a comparison is performed for each representative point or each pixel of two temporally continuous images. It should be noted that blur that is a detection target by the motion vector detection unit 104 can also be regarded as a position change within an angle of view of a subject.

As an example of an aspect ratio determination unit, the shape determination unit 107 determines the shape and the size of an image to be cropped (cut out) from a captured image based on an instruction from the operation unit 118. An image that is cropped from a captured image is sometimes referred to below as a crop image. In the image capturing apparatus 100 of the present embodiment, a plurality of templates are provided as rectangular crop images having different shapes, and the shape determination unit 107 determines the shape of the template selected by an operation of the user on the operation unit 118 to be the shape of the crop image. Examples of the plurality of templates include templates having different aspect ratios such as 4:3, 16:9, 9:16, and the like. In addition, the size of the crop image is defined by the number of vertical and horizontal pixels. In the image capturing apparatus 100, a plurality of templates may be provided in which the size of the crop image differs for each aspect ratio. In addition, each template may be a constant number of pixels regardless of aspect ratio. The shape determination unit 107 outputs shape information indicating the determined shape and size of the crop image to the crop unit 105, the position determination unit 106, and the correction amount determination unit 113.

As an example of a position determination unit, the position determination unit 106 determines the position to be cropped as the crop image from a captured image. More specifically, based on the vector information and the shape information, the position determination unit 106 determines the position to be cut out as the crop image so as to correct residual blur of the video electronically. In addition, the position determination unit 106 determines the position to be cut out as the crop image for each frame constituting the video. The position determination unit 106 outputs position information indicating the determined position to the crop unit 105.

The crop unit 105 electronically corrects residual blur of video by obtaining a crop image by cropping the image signal acquired from the image signal processing unit 103 based on the position information and the shape information. The crop unit 105 outputs the generated crop image to the display control unit 108 and the recording control unit 110.

The display control unit 108 controls the display device 109 to display the crop image. The display device 109 may be, for example, an LCD panel or the like.

The recording control unit 110 records the crop image in the recording medium 111 based on an instruction from the operation unit 118. The recording medium 111 may be, for example, a semiconductor memory, a hard disk, or the like.

The angular velocity sensor 112 is a sensor that physically detects an angular velocity applied to the image capturing apparatus 100 in accordance with the blur and the angular velocity sensor 112 outputs the detected angular velocity signal.

As an example of an angle of view control unit, the correction amount determination unit 113 determines a drive amount of the shift lens 115, and the correction amount determination unit 113 controls the angle of view of an image obtained by using the image capturing element 102 by causing the shift lens 115 to be driven by the determined drive amount. The correction amount determination unit 113 determines the drive amount of the shift lens 115 based on the angular velocity signal detected by the angular velocity sensor 112, the shape information, the image capturing size and the shutter speed obtained from the image capturing condition determination unit 116, and the focal length of the image capturing lens 101. It should be noted that driving of the shift lens 115 by the drive amount determined by the correction amount determination unit 113 is used for optical blur correction. Accordingly, the drive amount of the shift lens 115 determined by the correction amount determination unit 113 can also be regarded as a correction amount. In addition, the correction amount determination unit 113 can also be regarded as a movement amount determination unit that determines a movement amount of a drive target. The correction amount determination unit 113 outputs target information indicating a target position of the shift lens 115 from the determined drive amount to the lens motor drive unit 114.

As an example of a drive unit, the lens motor drive unit 114 performs conversion into a motor drive signal for driving the shift lens 115 and causes the shift lens 115 to be driven to a target position specified from target information.

The image capturing condition determination unit 116 determines an image capturing size or a shutter speed of the image capturing element 102 based on an instruction from the operation unit 118. The image capturing size is, for example, defined by resolutions such as 3840×2160 or 4096×2160 for standards such as UHD-4K (Ultra High Definition) or DCI-4K (Digital Cinema Initiative).

The image capturing control unit 117 controls the region to be read out as an image signal of the image capturing element 102 based on an image capturing size obtained from the image capturing condition determination unit 116. In addition, the image capturing control unit 117 controls an exposure time of the image capturing element 102 based on a shutter speed obtained from the image capturing condition determination unit 116. It should be noted that the shutter may be an electronic shutter or a mechanical shutter.

The operation unit 118 is a member that receives operations by a user for the image capturing apparatus 100. Examples of operations received by the operation unit 118 include presence or absence of recording of video, selection of a template to be used as the crop image, selection of the image capturing size, selection of the shutter speed, and the like. When the operation unit 118 receives an operation, the operation unit 118 outputs an instruction of the received operation. The operation unit 118 may be, for example, a button, a joystick, a touch panel, or the like. In addition, as the operation unit 118, a plurality of members may be provided for different types of operations to be received.

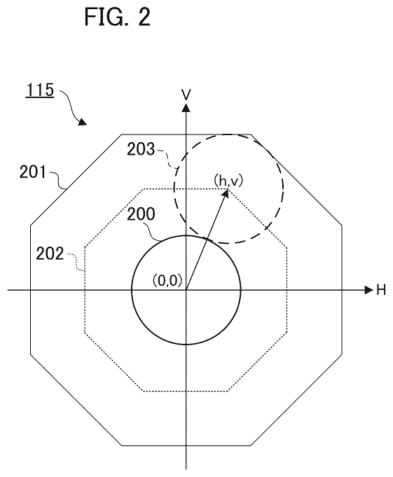

FIG. 2 is a schematic diagram of the shift lens 115 as viewed from the optical axis direction. It should be noted that, in FIG. 2, a horizontal axis H is the horizontal direction, and a vertical axis V is the vertical direction.

A lens 200 of the shift lens 115 is movable in the horizontal direction and in the vertical direction inside a movable end 201. In other words, a range in which the center of the lens 200 can be positioned by movement of the lens 200 is inside region 202. In addition, the dashed line region 203 is a region in which the lens 200 is positioned in a case in which the lens 200 has moved from a reference position to coordinates (h, v). A reference position of the lens 200 is a center position of the shift lens 115 and corresponds to coordinates (0, 0) shown in FIG. 2.

As shown in FIG. 2, in the present embodiment, the movable range of the lens 200 is defined as a regular octagonal shape centered on the reference position of the lens 200.

It should be noted that the lens 200 is an example of a drive target driven by a drive unit. In addition, the shift lens 115 can also be regarded, in a broad sense, as a drive target driven by a drive unit.

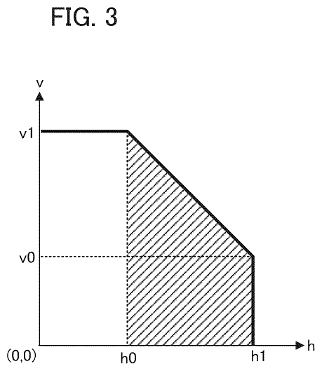

FIG. 3 is a diagram showing a relationship between a range in which the lens 200 is movable in the horizontal direction and a range in which the lens 200 is movable in the vertical direction. In FIG. 3, a horizontal axis h is a distance in the horizontal direction from a reference position of the lens 200, and a vertical axis v is a distance in the vertical direction from a reference position of the lens 200.

As shown in FIG. 3, in a case in which a movement distance of the lens 200 from the reference position in the horizontal direction is up to the distance h0, the limit distance in the vertical direction in which the lens 200 is movable from the reference position is the distance v1. The distance v1 is, in FIG. 2, a distance from the reference position to a position at which a boundary line of the region 202 (dotted-line portion in the figure) and the vertical axis V overlap. In addition, when a movement distance of the lens 200 in the horizontal direction becomes greater than the distance h0, the limit distance in the vertical direction in which the lens 200 is movable from the reference position becomes less than the distance v1. Specifically, in a range in which the movement distance of the lens 200 in the horizontal direction is greater than the distance h0 and is less than the distance h1, the greater the movement distance of the lens 200 in the horizontal direction becomes, the shorter the limit distance in the vertical direction in which the lens 200 is movable from the reference position becomes. In addition, in a case in which the movement distance of the lens 200 in the horizontal direction is the distance h1, the limit distance in the vertical direction in which the lens 200 is movable from the reference position is the distance v0.

In this context, a limit distance in the vertical direction in which the lens 200 is movable from the reference position, based on the current movement distance of the lens 200 from the reference position in the horizontal direction, is denoted as a vertical possible distance vp. In a range in which the movement distance of the lens 200 in the horizontal direction is greater than the distance h0 and is equal to or less than the distance h1 (a range indicated by hatching in the figure), the vertical possible distance vp is specified by Equation (1) below.

vp=v1−(v1−v0)/(h1−h0)×(h−h0) (Equation (1))

In Equation (1), h is the movement distance of the lens 200 in the horizontal direction.

In addition, in a case in which a movement distance of the lens 200 from the reference position in the vertical direction is up to the distance v0, a limit distance in the horizontal direction in which the lens 200 is movable from the reference position is the distance h1. The distance h1 is, in FIG. 2, a distance from the reference position to a position at which a boundary line of region 202 (dotted-line portion in the figure) and the horizontal axis H overlap. In addition, when a movement distance of the lens 200 in the vertical direction becomes greater than the distance v0, a limit distance in the horizontal direction in which the lens 200 is movable from the reference position becomes shorter than the distance h1. Specifically, in a range in which the movement distance of the lens 200 in the vertical direction is greater than the distance v0 and is less than a distance v1, the greater the movement distance of the lens 200 in the vertical direction becomes, the shorter the limit distance in the horizontal direction in which the lens 200 is movable from the reference position becomes. In addition, in a case in which the movement distance of the lens 200 in the vertical direction is the distance v1, a limit distance in the horizontal direction in which the lens 200 is movable from the reference position is the distance h0.

In this context, in consideration of a current movement distance of the lens 200 from the reference position in the vertical direction, a limit distance in the horizontal direction in which the lens 200 is movable from the reference position is denoted as a horizontal possible distance hp. In a range in which the movement distance of the lens 200 in the vertical direction is greater than the distance v0 and is equal to or less than the distance v1, the horizontal possible distance hp is specified by Equation (2) below.

hp=h1−(h1−h0)/(v1−v0)×(v−v0) (Equation (2))

In Equation (2), v is the movement distance of the lens 200 in the vertical direction.

It should be noted that the distance v1 is an upper-limit value of the limit distance in which the lens 200 is movable from the reference position in the vertical direction. Accordingly, the distance v1 is sometimes referred to below as a vertical upper-limit distance v1. In addition, the distance v0 is a lower-limit value of the limit distance in which the lens 200 is movable from the reference position in the vertical direction. Accordingly, the distance v0 is sometimes referred to below as a vertical lower-limit distance v0.

In addition, the distance h1 is an upper-limit value of the limit distance in which the lens 200 is movable from the reference position in the horizontal direction. Accordingly, the distance h1 is sometimes referred to below as a horizontal upper-limit distance h1. In addition, the distance h0 is a lower-limit value of the limit distance in which the lens 200 is movable from the reference position in the horizontal direction. Accordingly, the distance h0 is sometimes referred to below as a horizontal lower-limit distance h0.

In this manner, in the image capturing apparatus 100 of the present embodiment, when the lens 200 moves to one side in either the horizontal direction or the vertical direction, a range in which the lens 200 is movable to the other side is restricted.

It should be noted that, although in the present embodiment the movable end 201 of the shift lens 115 is explained as having a regular octagonal shape, the movable end 201 is not limited thereto. The movable end 201 of the shift lens 115 may be another shape in which, in response to movement of the lens 200 in one direction among the horizontal direction and the vertical direction, a limit of movement of the lens 200 in the other direction is restricted (for example, a polygonal shape different from a regular octagonal shape, a circular shape, and the like).

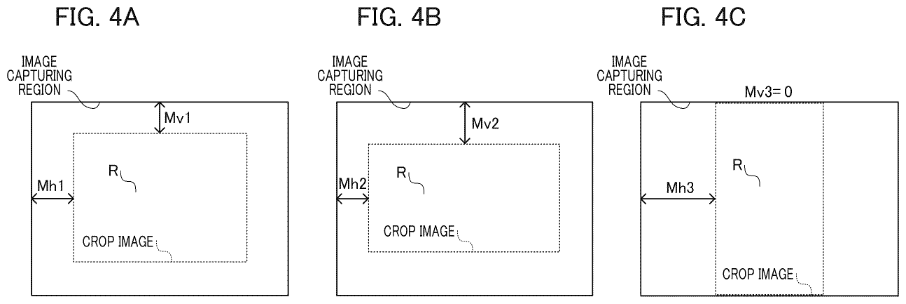

FIGS. 4A and 4C are diagrams showing a relationship between an image capturing region and a crop image. The image capturing region is a display region of a captured image.

FIGS. 4A to 4C show a relationship between the image capturing region and the crop image for each crop image of which the shape and the size are determined by the shape determination unit 107. More specifically, FIGS. 4A to 4C show, for each template having a different aspect ratio as a crop image, a relationship between the image capturing region and the crop image. It should be noted that, in all of FIGS. 4A to 4C, it is assumed that the center of the image capturing region and the center of the crop image coincide. In addition, in the present embodiment, for the purpose of maintaining image quality regardless of which template is selected as the crop image, as shown in FIGS. 4A to 4C, a size R (total number of pixels) of each crop image having a different aspect ratio is the same. However, a template in which the size R differs for each crop image having a different aspect ratio may be used.

The position determination unit 106 can determine a position of a crop image within a range of the image capturing region. In a case in which a crop image having the shape and the size shown in FIG. 4A is used, the position determination unit 106 can select a position of the crop image in a range of a distance Mv1 to one side in the vertical direction and a range of a distance Mh1 to one side in the horizontal direction from the center of the image capturing region. In other words, as electronic correction of blur, a maximum distance that is correctable in the vertical direction is the distance Mv1, and as electronic correction of blur, a maximum distance that is correctable in the horizontal direction is the distance Mh1.

In addition, the crop image shown in FIG. 4B is shorter in the vertical direction and longer in the horizontal direction than the crop image shown in FIG. 4A. In a case in which this crop image is used, the position determination unit 106 can select a position of the crop image in a range of a distance Mv2 to one side in the vertical direction and a range of a distance Mh2 to one side in the horizontal direction from the center of the image capturing region. That is, as electronic correction of blur, a maximum distance that is correctable in the vertical direction is the distance Mv2, and as electronic correction of blur, a maximum distance that is correctable in the horizontal direction is the distance Mh2. In this context, the distance Mv2 is greater than the distance Mv1. In addition, the distance Mh2 is less than the distance Mh1.

In addition, the crop image shown in FIG. 4C is longer in the vertical direction and shorter in the horizontal direction than the crop image shown in FIG. 4A. It should be added that, in the crop image shown in FIG. 4C, the length in the vertical direction is equal to the length of the image capturing region. In a case in which the crop image shown in FIG. 4C is used, the position determination unit 106 can select a position of the crop image in a range of a distance Mv3 to one side in the vertical direction and a range of a distance Mh3 to one side in the horizontal direction from the center of the image capturing region. That is, as electronic correction of blur, a maximum distance that is correctable in the vertical direction is the distance Mv3, and as electronic correction of blur, a maximum distance that is correctable in the horizontal direction is the distance Mh3. In this context, the distance Mv3 is 0. That is, in a case in which the crop image shown in FIG. 4C is used, correction of blur in the vertical direction cannot be performed using this crop image. In addition, the distance Mh3 is greater than the distance Mh1.

It should be noted that the maximum distance that is correctable in the vertical direction as electronic correction of blur is sometimes referred to below as the electronic vertical distance Mv. In addition, the maximum distance that is correctable in the horizontal direction as electronic correction of blur is sometimes referred to below as the electronic horizontal distance Mh. The electronic vertical distance Mv and the electronic horizontal distance Mh are defined in accordance with selection of a template to be used as the crop image. As an example, in a case in which the template of the crop image shown in FIG. 4A is selected, the electronic vertical distance Mv is the distance Mv1, and the electronic horizontal distance Mh is the distance Mh1.

In this manner, depending on a shape of a crop image, a degree to which electronic correction is possible differs between the horizontal direction and the vertical direction. When the extent of possible electronic correction differs between the horizontal direction and the vertical direction, a difference in an effect of correction between the horizontal direction and the vertical direction becomes large, and there is a concern that the quality of the video decreases. In particular, in a case in which the crop image shown in FIG. 4C is used, an effect of correction of blur in the vertical direction cannot be obtained by the crop image.

As a technique for suppressing an increase in the difference in the effect of correction between the horizontal direction and the vertical direction that is caused by a difference in the degree to which electronic correction is possible between the horizontal direction and the vertical direction, one technique supplements the electronic correction by correction using the shift lens 115. For example, in a case in which the crop image shown in FIG. 4C is used, by moving the lens 200 of the shift lens 115 in the vertical direction, correction of blur in the vertical direction, for which electronic correction cannot be performed, is performed. However, as described above, in the image capturing apparatus 100 of the present embodiment, when the lens 200 moves to one side in either the horizontal direction or the vertical direction, a range in which the lens 200 is movable to the other side is restricted (refer to FIG. 3). In this case, in a case in which blur occurs in both the horizontal direction and the vertical direction, there is a concern that correction of blur in both the horizontal direction and the vertical direction cannot be sufficiently performed.

Accordingly, in the present embodiment, the movable range of the lens 200 in the vertical direction and the movable range of the lens 200 in the horizontal direction are defined based on the shape of the crop image. More specifically, in a case in which electronic correction in one direction among the horizontal direction and the vertical direction cannot be sufficiently performed, the movable range of the lens 200 in the vertical direction and the horizontal direction is defined so that correction by the shift lens 115 in the one direction is not restricted.

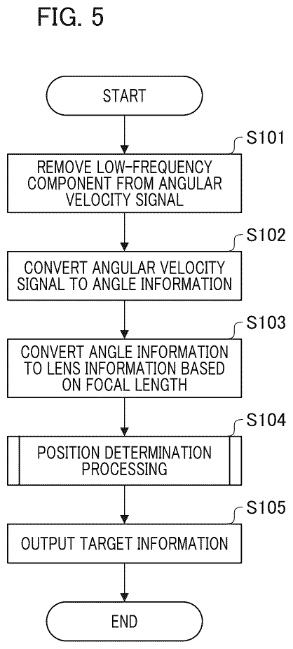

FIG. 5 is a flowchart diagram showing a flow of correction amount determination processing. The correction amount determination processing shown in FIG. 5 is processing in which the correction amount determination unit 113 determines a correction amount of blur using the shift lens 115. In the present embodiment, when an angular velocity signal detected by the angular velocity sensor 112, information indicating a focal length of the image capturing lens 101, information indicating a shutter speed, and shape information are received by the correction amount determination unit 113, the correction amount determination processing is started.

The correction amount determination unit 113 removes low-frequency components from the angular velocity signal (step (hereinafter, sometimes referred to as “S”) 101). Removal of the low-frequency components is performed by an HPF (High-Pass Filter) (not shown) that is included in the correction amount determination unit 113.

The correction amount determination unit 113 converts the angular velocity signal from which the low-frequency components have been removed into angle information indicating an angle by temporally integrating the angular velocity signal by an integrator (not shown) (step S102).

The correction amount determination unit 113 converts the angle information into lens information indicating a position of the lens 200 based on the focal length of the image capturing lens 101 (step S103). The position of the lens 200 identified from the lens information is a position of the lens 200 in a case in which correction by a correction amount as an ideal value identified by the correction amount determination unit 113 is performed. Accordingly, a position of the lens 200 identified from the lens information is sometimes referred to below as an ideal position of the lens 200. In addition, a distance in a horizontal direction from a reference position of the lens 200 to the ideal position is sometimes referred to below as the horizontal ideal distance ht. In addition, a distance in a vertical direction from the reference position of the lens 200 to the ideal position is sometimes referred to below as the vertical ideal distance vt.

The correction amount determination unit 113 performs position determination processing by using the lens information (step S104). Although details are described below, in the position determination processing, a final target position of the lens 200 is determined based on a physically correctable range of the shift lens 115, the shutter speed, the electronic vertical distance Mv, and the electronic horizontal distance Mh. The final target position of the lens 200 is a position of the lens 200 in a case in which correction by a final correction amount identified by the correction amount determination unit 113 is performed. That is, by the final target position being determined, a correction amount of blur is determined. In addition, the position determination processing is performed, for example, by a limiter (not shown) of the correction amount determination unit 113.

The correction amount determination unit 113 outputs target information indicating the determined target position of the lens 200 to the lens motor drive unit 114 (step S105).

The correction amount determination unit 113 repeatedly performs the above-described correction amount determination processing for each frame of video.

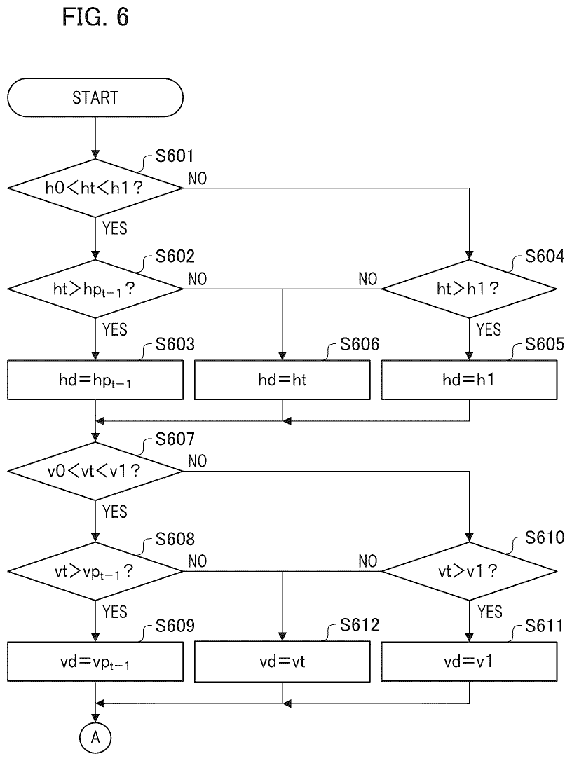

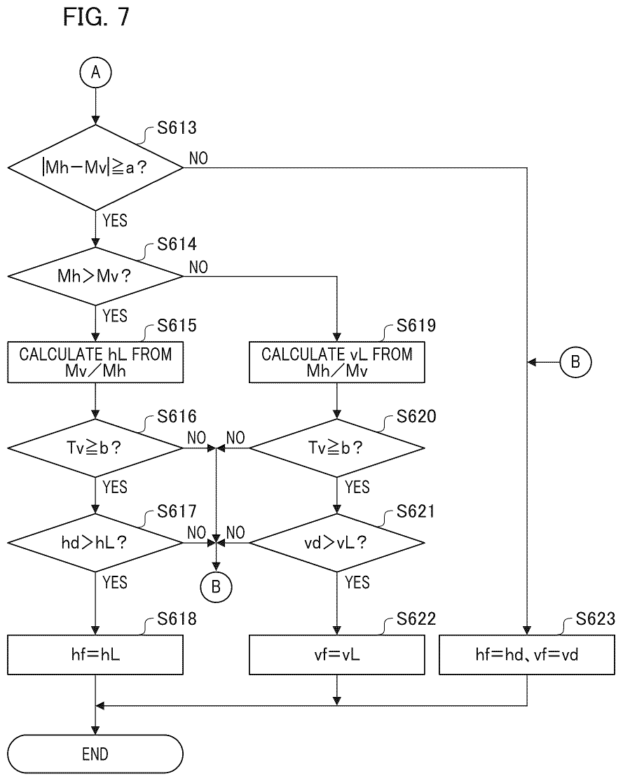

FIG. 6 and FIG. 7 are flowchart diagrams showing a flow of the position determination processing.

The correction amount determination unit 113 determines whether or not the horizontal ideal distance ht is greater than the horizontal lower-limit distance h0 and is less than the horizontal upper-limit distance h1 (step S601).

In a case in which the horizontal ideal distance ht is greater than the horizontal lower-limit distance h0 and less than the horizontal upper-limit distance h1 (Yes in step S601), processing proceeds to the next step. The correction amount determination unit 113 determines whether or not the horizontal ideal distance ht is greater than the horizontal possible distance hpt-1 when the previous position determination processing was performed (step S602). The horizontal possible distance hpt-1 when the previous position determination processing was performed is a horizontal possible distance when position determination processing targeting the frame one frame prior to the frame that is a target of the position determination processing being executed was performed. The horizontal possible distance hpt-1 when the previous position determination processing was performed is identified from Equation (3) below.

hpt-1=h1−(h1−h0)/(v1−v0)×(vt-1−v0) (Equation (3))

In Equation (3), the distance vt-1 is a distance in the vertical direction from the reference position of the lens 200 to a final target position determined in the previous position determination processing. That is, the distance vt-1 is a distance in the vertical direction from the reference position of the lens 200 to a current position of the lens 200.

It should be noted that, in a case in which a frame that is a target of the position determination processing being executed is a first frame in the video, a negative result is obtained in step 602 (No in step S602).

In a case in which the horizontal ideal distance ht is greater than the horizontal possible distance hpt-1 when the previous position determination processing was performed (Yes in step S602), processing proceeds to the next step. The correction amount determination unit 113 sets the target horizontal distance hd, the target horizontal distance hd being a distance in the horizontal direction from the reference position of the lens 200 to a target position to which the lens 200 is to be moved by correction, to the horizontal possible distance hpt-1 when the previous position determination processing was performed (step S603).

In addition, in a case in which the horizontal ideal distance ht is less than the horizontal lower-limit distance h0 or greater than the horizontal upper-limit distance h1 (No in step S601), the correction amount determination unit 113 determines whether or not the horizontal ideal distance ht is greater than the horizontal upper-limit distance h1 (step S604).

In a case in which the horizontal ideal distance ht is greater than the horizontal upper-limit distance h1 (Yes in step S604), the correction amount determination unit 113 determines the target horizontal distance hd to be the horizontal upper-limit distance h1 (step S605).

In addition, in a case in which the horizontal ideal distance ht is equal to or less than the horizontal possible distance hpt-1 when the previous position determination processing was performed (No in step S602), or in a case in which the horizontal ideal distance ht is less than the horizontal lower-limit distance h0 (No in step S604), processing proceeds to the next step. In this case, the correction amount determination unit 113 determines the target horizontal distance hd to be the horizontal ideal distance ht (step S606).

The correction amount determination unit 113 determines whether or not the vertical ideal distance vt is greater than the vertical lower-limit distance v0 and less than the vertical upper-limit distance v1 (step S607).

In a case in which the vertical ideal distance vt is greater than the vertical lower-limit distance v0 and less than the vertical upper-limit distance v1 (Yes in step S607), processing proceeds to the next step. The correction amount determination unit 113 determines whether or not the vertical ideal distance vt is greater than the vertical possible distance vpt-1 when the previous position determination processing was performed (step S608). The vertical possible distance vpt-1 when the previous position determination processing was performed is a vertical possible distance when position determination processing targeting the frame one frame prior to the frame that is a target of the position determination processing being executed was performed. The vertical possible distance vpt-1 when the previous position determination processing was performed is identified from Equation (4) described below.

vpt-1=v1−(v1−v0)/(h1−h0)×(ht-1−h0) (Equation (4))

In Equation (4), the distance ht-1 is the distance in the horizontal direction from the reference position of the lens 200 to a final target position determined in the previous position determination processing. In other words, the distance ht-1 is a distance in the horizontal direction from the reference position of the lens 200 to a current position of the lens 200.

It should be noted that, in a case in which a frame that is a target of the position determination processing being executed is a first frame in the video, a negative result is obtained in step 608 (No in step S608).

In a case in which the vertical ideal distance vt is greater than the vertical possible distance vpt-1 when the previous position determination processing was performed (Yes in step S608), processing proceeds to the next step. The correction amount determination unit 113 sets the target vertical distance vd, the target vertical distance vd being a distance in the vertical direction from the reference position of the lens 200 to a target position to which the lens 200 is to be moved by correction, to the vertical possible distance vpt-1 when the previous position determination processing was performed (step S609).

In addition, in a case in which the vertical ideal distance vt is less than the vertical lower-limit distance v0 or greater than the vertical upper-limit distance v1 (No in step S607), the correction amount determination unit 113 determines whether or not the vertical ideal distance vt is greater than the vertical upper-limit distance v1 (step S610).

In a case in which the vertical ideal distance vt is greater than the vertical upper-limit distance v1 (Yes in step S610), the correction amount determination unit 113 determines the target vertical distance vd to be the vertical upper-limit distance v1 (step S611).

In addition, in a case in which the vertical ideal distance vt is equal to or less than the vertical possible distance vpt-1 when the previous position determination processing was performed (No in step S608), or in a case in which the vertical ideal distance vt is less than the vertical lower-limit distance v0 (No in step S610), processing proceeds to the next step. In this case, the correction amount determination unit 113 determines the target vertical distance vd to be the vertical ideal distance vt (step S612).

In this manner, in the position determination processing, the correction amount determination unit 113 determines a target position to which the lens 200 is to be moved by correction from the reference position of the lens 200 so as not to exceed a physically movable range of the shift lens 115.

The correction amount determination unit 113 determines whether or not the difference between the electronic horizontal distance Mh and the electronic vertical distance Mv is equal to or greater than the restriction threshold value a (step S613). The restriction threshold value a is a value predetermined as a threshold value that restricts optical correction in the direction of the greater of the electronic horizontal distance Mh and the electronic vertical distance Mv. The restriction threshold value a is provided in order to suppress a large difference in an effect of blur correction between the horizontal direction and the vertical direction from occurring.

In a case in which the difference between the electronic horizontal distance Mh and the electronic vertical distance Mv is equal to or greater than the restriction threshold value (Yes in step S613), the correction amount determination unit 113 determines whether or not the electronic horizontal distance Mh is greater than the electronic vertical distance Mv (step S614).

In a case in which the electronic horizontal distance Mh is greater than the electronic vertical distance Mv (Yes in step S614), the correction amount determination unit 113 calculates a horizontal restriction distance hL based on a ratio of the electronic vertical distance Mv to the electronic horizontal distance Mh (step S615). The horizontal restriction distance hL is, as a limit distance in the horizontal direction in which the lens 200 is movable from the reference position, a distance restricted based on the ratio of the electronic vertical distance Mv to the electronic horizontal distance Mh. The horizontal restriction distance hL is calculated from Equation (5) described below.

hL=Mv/Mh×(h1−h0)+h0 (Equation (5))

In this case, the horizontal restriction distance hL is calculated to be a value greater than h0 and less than h1.

The correction amount determination unit 113 determines whether or not a shutter speed Tv is equal to or greater than the restriction relaxation threshold value b (step S616). The restriction relaxation threshold value b is a predetermined threshold value for relaxing restriction based on a ratio of the electronic vertical distance Mv to the electronic horizontal distance Mh on a limit distance that the lens 200 can move from the reference position in the horizontal direction. The restriction relaxation threshold value b is provided in order to relax restriction, based on the ratio of the electronic vertical distance Mv to the electronic horizontal distance Mh, on a limit distance that the lens 200 can move from the reference position in the horizontal direction in a case in which the shutter speed Tv is slow.

In electronic blur correction using a crop image, as the shutter speed Tv becomes slower, exposure accumulation blur during exposure time tends to occur more easily. In contrast, in optical blur correction, because an image-forming position changes optically, exposure accumulation blur tends to occur less easily regardless of the shutter speed Tv. Accordingly, in a case in which the shutter speed is slow, optical blur correction has higher correction accuracy than electronic blur correction. Accordingly, the restriction relaxation threshold value b is provided so that a limit distance that the lens 200 can move in the horizontal direction is not restricted in a case in which the shutter speed Tv is slow, and a limit distance that the lens 200 can move in the horizontal direction is restricted in a case in which the shutter speed Tv is fast.

In a case in which the shutter speed Tv is equal to or greater than the restriction relaxation threshold value b (Yes in step S616), the correction amount determination unit 113 determines whether or not the target horizontal distance hd is greater than the horizontal restriction distance hL (step S617).

In a case in which the target horizontal distance hd is greater than the horizontal restriction distance hL (Yes in step S617), processing proceeds to the next step. The correction amount determination unit 113 determines a final horizontal distance hf as a distance in the horizontal direction from the reference position of the lens 200 to a final target position to which the lens 200 is to be moved by correction, wherein the final horizontal distance hf is set to the horizontal restriction distance hL (step S618). That is, the correction amount determination unit 113 restricts the final horizontal distance hf to be less than a limit distance that the lens 200 can move from the reference position in the horizontal direction based on a position of the lens 200 in the vertical direction. In other words, the correction amount determination unit 113 restricts the final horizontal distance hf to be less than the target horizontal distance hd.

In addition, in a case in which the electronic vertical distance Mv is greater than the electronic horizontal distance Mh (No in step S614), the correction amount determination unit 113 calculates a vertical restriction distance vL based on a ratio of the electronic horizontal distance Mh to the electronic vertical distance Mv (step S619). The vertical restriction distance vL is a distance that is restricted based on a ratio of the electronic horizontal distance Mh to the electronic vertical distance Mv, the vertical restriction distance vL serving as a limit distance in the vertical direction in which the lens 200 is movable from the reference position. The vertical restriction distance vL is calculated from Equation (6) described below.

vL=Mh/Mv×(v1−v0)+v0 (Equation (6))

In this case, the vertical restriction distance vL is calculated to be a value greater than v0 and less than v1.

The correction amount determination unit 113 determines whether or not the shutter speed Tv is equal to or greater than the restriction relaxation threshold value b (step S620).

In a case in which the shutter speed Tv is equal to or greater than the restriction relaxation threshold value b (Yes in step S620), the correction amount determination unit 113 determines whether or not the target vertical distance vd is greater than the vertical restriction distance vL (step S621).

In a case in which the target vertical distance vd is greater than the vertical restriction distance vL (Yes in step S621), processing proceeds to the next step. The correction amount determination unit 113 determines a final vertical distance vf as a distance in the vertical direction from the reference position of the lens 200 to a final target position to which the lens 200 is to be moved by correction, wherein the final vertical distance vf is set to the vertical restriction distance vL (step S622). That is, the correction amount determination unit 113 restricts the final vertical distance vf to be less than a limit distance that the lens 200 can move from the reference position in the vertical direction based on a position of the lens 200 in the horizontal direction. In other words, the correction amount determination unit 113 restricts the final vertical distance vf to be less than the target vertical distance vd.

In addition, there is a case in which a difference between the electronic horizontal distance Mh and the electronic vertical distance Mv is less than the restriction threshold value a (No in step S613), or a case in which the shutter speed Tv is less than the restriction relaxation threshold value b (No in step S616, No in step S620). In addition, there is a case in which the target horizontal distance hd is equal to or less than the horizontal restriction distance hL (No in step S617), or a case in which the target vertical distance vd is equal to or less than the vertical restriction distance vL (No in step S621). In this case, the correction amount determination unit 113 determines the final horizontal distance hf to be the target horizontal distance hd, and determines the final vertical distance vf to be the target vertical distance vd (step S623).

It should be noted that, in step S618, the correction amount determination unit 113 determines the final vertical distance vf to be the target vertical distance vd. In addition, in step S622, the correction amount determination unit 113 determines the final horizontal distance hf to be the target horizontal distance hd.

In this manner, in the present embodiment, in a case in which an electronically correctable amount in the other of the horizontal direction and the vertical direction is greater than that in the one direction, correction by the shift lens 115 in the other direction is restricted. In this case, even in a case in which electronic correction in the one direction cannot be sufficiently performed, correction by the shift lens 115 in the one direction becomes less easily restricted, and occurrence of excessive bias in an effect of blur correction between the horizontal direction and the vertical direction is suppressed.

It should be noted that, although processing in a case in which a movable end 201 of the shift lens 115 has an octagonal shape is explained in the above-described position determination processing, the position determination processing is not limited thereto. The movable end 201 of the shift lens 115 may have another shape in which, in accordance with movement of the lens 200 in one of the horizontal direction and the vertical direction, a limit at which movement in the other direction is possible is restricted, for example, a polygonal shape different from an octagonal shape, a circular shape, and the like. In this case, by performing calculation corresponding to another shape, occurrence of excessive bias in an effect of blur correction between the horizontal direction and the vertical direction may be suppressed.

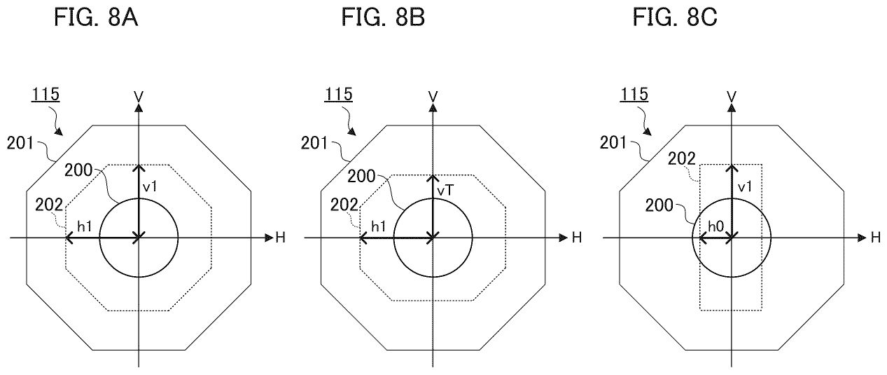

FIGS. 8A and 8C are diagrams showing a movable range of the lens 200 determined in the position determination processing. It should be noted that FIGS. 8A and 8C are, similar to FIG. 2, schematic diagrams of the shift lens 115 as viewed from the optical axis direction. In FIGS. 8A and 8C, a horizontal axis H indicates the horizontal direction, and a vertical axis V indicates the vertical direction. In FIGS. 8A to 8C, the movable range of the lens 200 determined in the position determination processing is shown for each template selected as the crop image. More specifically, in FIG. 8A, in a case in which the crop image shown in FIG. 4A is selected as the template, the movable range of the lens 200 determined in the position determination processing is shown. In addition, in FIG. 8B, in a case in which the crop image shown in FIG. 4B is selected as the template, the movable range of the lens 200 determined in the position determination processing is shown. In addition, in FIG. 8C, in a case in which the crop image shown in FIG. 4C is selected as the template, the movable range of the lens 200 determined in the position determination processing is shown.

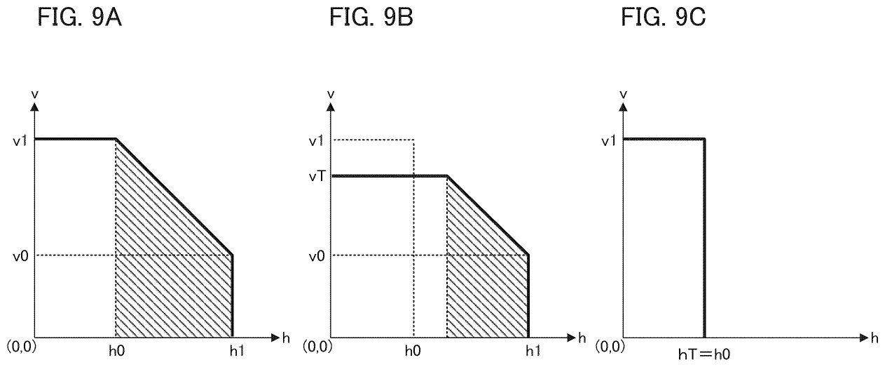

In addition, FIGS. 9A and 9C are diagrams showing a relationship between a movable range of the lens 200 in the horizontal direction and a movable range of the lens 200 in the vertical direction that are determined in the position determination processing. In FIGS. 9A and 9C, a horizontal axis h indicates a distance from a reference position of the lens 200 in the horizontal direction, and a vertical axis v indicates a distance from a reference position of the lens 200 in the vertical direction. In FIGS. 9A to 9C, the relationship between the movable range of the lens 200 in the horizontal direction and the movable range of the lens 200 in the vertical direction that are determined in the position determination processing is shown for each template selected as the crop image. More specifically, in FIG. 9A, in a case in which the crop image shown in FIG. 4A is selected as the template, the relationship between the movable range of the lens 200 in the horizontal direction and the movable range of the lens 200 in the vertical direction that are determined in the position determination processing is shown. In addition, in FIG. 9B, in a case in which the crop image shown in FIG. 4B is selected as the template, the relationship between the movable range of the lens 200 in the horizontal direction and the movable range of the lens 200 in the vertical direction that are determined in the position determination processing is shown. In addition, in FIG. 9C, in a case in which the crop image shown in FIG. 4C is selected as the template, the relationship between the movable range of the lens 200 in the horizontal direction and the movable range of the lens 200 in the vertical direction that are determined in the position determination processing is shown.

By using FIGS. 8A and 8C and FIGS. 9A and 9C, an explanation is provided with respect to the movable range of the lens 200 for each template selected as the crop image.

In a case in which, as in the crop image shown in FIG. 4A, a crop image in which a difference between the electronic horizontal distance Mh and the electronic vertical distance Mv is less than the restriction threshold value a is selected as the template, the movable range of the lens 200 is set based only on the movable end 201. In this case, a maximum value of a movement distance of the lens 200 from the reference position in the vertical direction that can be determined in the position determination processing is, as shown in FIGS. 8A and 9A, the vertical upper-limit distance v1. In addition, a maximum value of a movement distance of the lens 200 from the reference position in the horizontal direction that can be determined in the position determination processing is the horizontal upper-limit distance h1. In addition, a region 202 in which the center of the lens 200 can be positioned by movement of the lens 200 is the same size in the horizontal direction and in the vertical direction.

In addition, in a case in which, as in the crop image shown in FIG. 4B, a crop image in which the electronic vertical distance Mv is greater than the electronic horizontal distance Mh by more than the restriction threshold value a is selected as the template, a movable distance of the lens 200 in the vertical direction is restricted to be shorter than the vertical upper-limit distance v1. In this case, a maximum value of a movement distance of the lens 200 from the reference position in the vertical direction that can be determined in the position determination processing is, as shown in FIGS. 8B and 9B, a distance vT shorter than the vertical upper-limit distance v1. In addition, a maximum value of a movement distance of the lens 200 from the reference position in the horizontal direction that can be determined in the position determination processing is the horizontal upper-limit distance h1. In addition, the region 202 in which the center of the lens 200 can be positioned by movement of the lens 200 is larger in the horizontal direction than in the vertical direction.

In addition, as in the crop image shown in FIG. 4C, there is a case in which a crop image in which the electronic horizontal distance Mh is greater than the electronic vertical distance Mv by more than the restriction threshold value a and the electronic vertical distance Mv is 0 is selected as the template. In this case, a movable distance of the lens 200 in the horizontal direction is restricted more than the horizontal upper-limit distance h1. More specifically, a maximum value of a movement distance of the lens 200 from the reference position in the horizontal direction that can be determined in the position determination processing is, as shown in FIGS. 8C and 9C, the horizontal lower-limit distance h0 shorter than the horizontal upper-limit distance h1. In addition, a maximum value of a movement distance of the lens 200 from the reference position in the vertical direction that can be determined in the position determination processing is the vertical upper-limit distance v1. In addition, the region 202 in which the center of the lens 200 can be positioned by movement of the lens 200 is larger in the vertical direction than in the horizontal direction.

### Second Embodiment

Next, an explanation is provided with respect to the image capturing apparatus 100 of a Second Embodiment. It should be noted that, in the Second Embodiment, a configuration that is different from the image capturing apparatus 100 of the First Embodiment is explained, and explanation is omitted with respect to a configuration that is the same as the image capturing apparatus 100 of the First Embodiment.

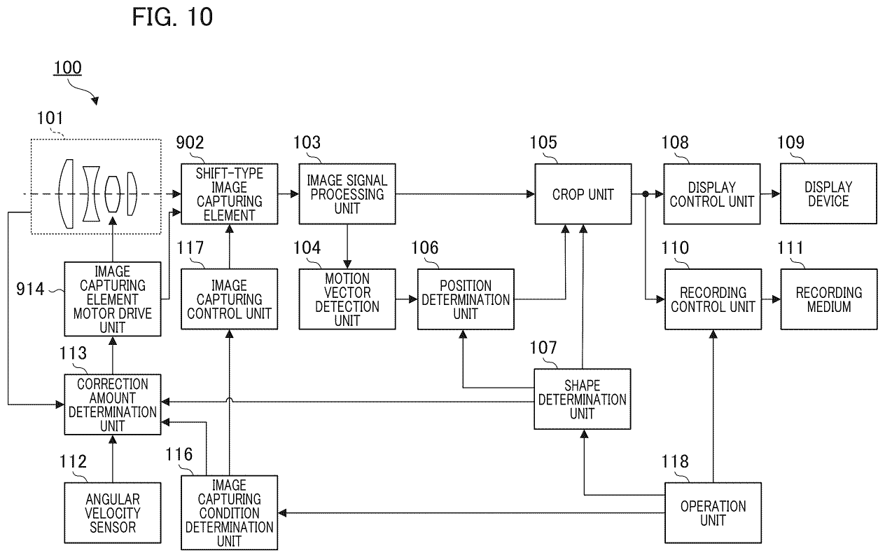

FIG. 10 is an overall configuration diagram of the image capturing apparatus 100 in the Second Embodiment. In the image capturing apparatus 100 of the present embodiment, a shift-type image capturing element 902 is provided in place of the image capturing element 102 (refer to FIG. 1) provided in the image capturing apparatus 100 of the First Embodiment. In addition, in the image capturing apparatus 100 of the present embodiment, an image capturing element motor drive unit 914 is provided in place of the lens motor drive unit 114 (refer to FIG. 1) provided in the image capturing apparatus 100 of the First Embodiment.

The shift-type image capturing element 902 converts a subject image obtained through the image capturing lens 101 into an electric signal by exposing the subject image for a predetermined time based on a shutter speed. In addition, the shift-type image capturing element 902 optically corrects blur that occurs in the image capturing apparatus 100 by moving based on a motor drive signal obtained from the motor drive unit 914 and changing an image formation position. Examples of movement of the shift-type image capturing element 902 include horizontal movement in a direction orthogonal to the optical axis of the image capturing lens 101, vertical movement in a direction orthogonal to the optical axis of the image capturing lens 101, and rotation having the optical axis of the image capturing lens 101 as a center axis.

The correction amount determination unit 113 determines a drive amount of the shift-type image capturing element 902 based on the angular velocity signal detected by the angular velocity sensor 112, the shape information, the image capturing size and the shutter speed obtained from the image capturing condition determination unit 116, and the focal length of the image capturing lens 101. Driving of the shift-type image capturing element 902 by the drive amount determined by the correction amount determination unit 113 is used for optical blur correction. Accordingly, the drive amount of the shift-type image capturing element 902 determined by the correction amount determination unit 113 can also be regarded as a correction amount. The correction amount determination unit 113 outputs target information indicating a target position of the shift-type image capturing element 902 from the determined drive amount to the image capturing element motor drive unit 914.

As an example of a drive unit, the image capturing element motor drive unit 914 converts the target information into a motor drive signal for driving the shift-type image capturing element 902 and causes the shift-type image capturing element 902 to be driven to a target position specified from the target information.

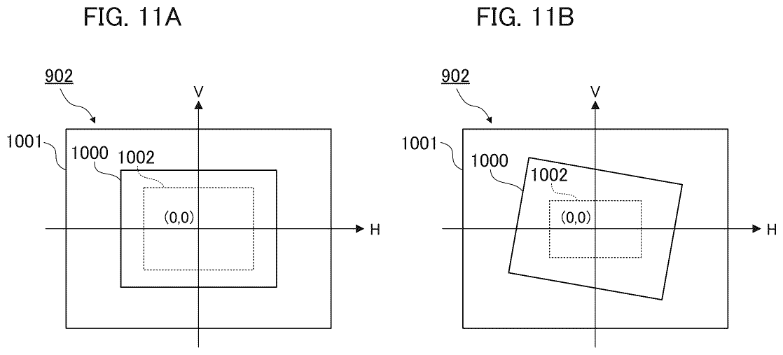

FIGS. 11A and 11B are schematic diagrams of the shift-type image capturing element 902 as viewed from the optical axis direction. It should be noted that, in FIGS. 11A and 11B, a horizontal axis H indicates the horizontal direction, and a vertical axis V indicates the vertical direction.

As shown in FIG. 11A, an image capturing element 1000 of the shift-type image capturing element 902 is movable in the horizontal direction and in the vertical direction inside a movable end 1001.

That is, a range in which the center of the image capturing element 1000 can be positioned by the image capturing element 1000 moving in the horizontal direction and the vertical direction in a state in which the image capturing element 1000 is not rotated is inside a region 1002. It should be noted that, in the illustrated example, the image capturing element 1000 is positioned at a reference position. The reference position of the image capturing element 1000 is the center position of the shift-type image capturing element 902 corresponding to coordinates (0, 0) shown in FIG. 11A and is a position in a state in which the image capturing element 1000 is not rotated.

In addition, the region 1002 of a range in which the center of the image capturing element 1000 can be positioned by the image capturing element 1000 moving in the horizontal direction and in the vertical direction in a state in which the image capturing element 1000 is rotated as shown in FIG. 11B becomes smaller than in a state in which the image capturing element 1000 is not rotated. This is due to the fact that, in a state in which the image capturing element 1000 is rotated, both a distance in the horizontal direction from the image capturing element 1000 to the movable end 1001 and a distance in the vertical direction from the image capturing element 1000 to the movable end 1001 become shorter than in a state in which the image capturing element 1000 is not rotated. In this manner, in the shift-type image capturing element 902, in a case in which the image capturing element 1000 is rotated, compared to a case in which the image capturing element 1000 is not rotated, movable ranges in the horizontal direction and in the vertical direction are physically restricted.

It should be noted that the image capturing element 1000 is an example of a drive unit by a drive target. In addition, the shift-type image capturing element 902 can also be regarded, in a broad sense, as a drive unit by a drive target.

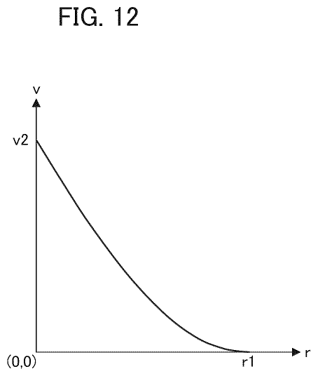

FIG. 12 is a diagram showing a relationship between a range in which the image capturing element 1000 is movable in the vertical direction and a range in which the image capturing element 1000 is rotatable. In FIG. 12, a horizontal axis r indicates a rotation angle, and a vertical axis v indicates a distance in the vertical direction from the reference position of the image capturing element 1000.

As shown in FIG. 12, in a case in which the image capturing element 1000 is not rotated, the limit distance in the vertical direction in which the image capturing element 1000 is movable from the reference position is the distance v2. The distance v2 is, in FIG. 11A, a distance from the reference position to a position at which a boundary line of the region 1002 (dotted-line portion in the figure) and the vertical axis V overlap. In addition, the larger the rotation angle of the image capturing element 1000 becomes, the shorter the limit distance in the vertical direction in which the image capturing element 1000 is movable from the reference position becomes.

In addition, in a case in which the image capturing element 1000 is not moved in the vertical direction, the limit angle at which the image capturing element 1000 can rotate is the angle r1. In addition, the more the image capturing element 1000 moves in the vertical direction, the smaller the limit angle at which the image capturing element 1000 can rotate becomes.

It should be noted that, although an illustration is omitted, a relationship between a range in which the image capturing element 1000 is movable in the horizontal direction and a range in which the image capturing element 1000 is rotatable is the same as the relationship shown in FIG. 12 between a range in which the image capturing element 1000 is movable in the vertical direction and a range in which the image capturing element 1000 is rotatable.

In addition, the distance v2 is an upper-limit value of the limit distance in the vertical direction in which the image capturing element 1000 is movable from the reference position. For this reason, the distance v2 is sometimes referred to below as a vertical upper-limit distance v2. In addition, an upper-limit value of the limit distance in the horizontal direction in which the image capturing element 1000 is movable from the reference position is sometimes referred to below as a horizontal upper-limit distance h2.

In addition, the angle r1 is the limit rotation angle at which the image capturing element 1000 can rotate. For this reason, the angle r1 is sometimes referred to below as an upper-limit rotation angle r1. In the present embodiment, it is assumed that the upper-limit rotation angle r1 is equal to or less than 90°.

In this manner, in the image capturing apparatus 100 of the present embodiment, when the image capturing element 1000 moves in the vertical direction or in the horizontal direction, rotation of the image capturing element 1000 is restricted. In addition, when the image capturing element 1000 rotates, movement of the image capturing element 1000 in the vertical direction and in the horizontal direction is restricted.

It should be noted that, although in the present embodiment the movable end 1001 of the image capturing element 1000 is explained as having a rectangular shape, the movable end 1001 is not limited thereto. The movable end 1001 of the image capturing element 1000 may be another shape in which, in response to one operation among movement of the image capturing element 1000 in the horizontal direction or in the vertical direction and rotation of the image capturing element 1000, a limit of the other operation is restricted (for example, a polygonal shape different from a rectangular shape, and the like).

In addition, as described above, depending on a shape of a crop image, a degree to which electronic correction is possible differs between the horizontal direction and the vertical direction, and a difference in an effect of electronic correction of blur between the horizontal direction and the vertical direction may become large. In this case, there is a technique in which the electronic correction is supplemented by correction using the shift-type image capturing element 902. However, as described above, in the image capturing apparatus 100 of the present embodiment, in response to one operation among movement of the image capturing element 1000 in the horizontal direction or in the vertical direction and rotation of the image capturing element 1000, a limit of the other operation of the image capturing element 1000 is restricted (refer to FIG. 12). In this case, in a case in which blur occurs in a direction of one of the horizontal direction and the vertical direction of the image capturing element 1000 and in a rotation direction, there is a concern that correction of blur in both the direction and the rotation direction cannot be sufficiently performed.

Accordingly, in the present embodiment, the movable range of the image capturing element 1000 in the horizontal direction, the movable range of the image capturing element 1000 in the vertical direction, and a range in which the image capturing element 1000 is rotatable are defined based on a shape of a crop image. More specifically, in a case in which electronic correction in the horizontal direction or in the vertical direction cannot be sufficiently performed, a range in which the image capturing element 1000 is rotatable is defined so that correction by the shift-type image capturing element 902 in the direction in which correction cannot be sufficiently performed is not restricted.

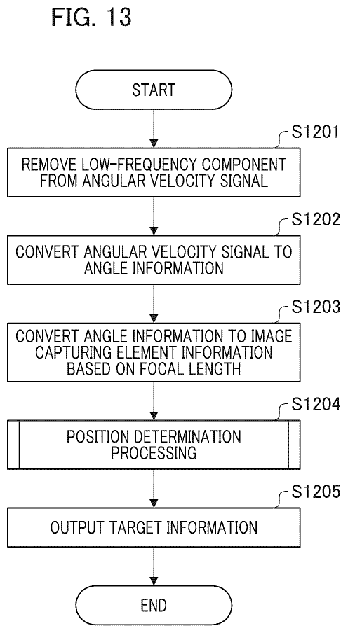

FIG. 13 is a flowchart diagram showing a flow of the correction amount determination processing. The correction amount determination processing shown in FIG. 13 is processing in which the correction amount determination unit 113 determines a correction amount of blur using the shift-type image capturing element 902. In the present embodiment, when the angular velocity signal detected by the angular velocity sensor 112, information indicating a focal length of the image capturing lens 101, information indicating a shutter speed, and the shape information are received by the correction amount determination unit 113, the correction amount determination processing is started.

The correction amount determination unit 113 removes the low-frequency component from the angular velocity signal (step S1201). Removal of the low-frequency component is performed by an HPF (High-Pass Filter) (not shown) included in the correction amount determination unit 113.

The correction amount determination unit 113 converts the angular velocity signal from which the low-frequency component has been removed into angle information indicating an angle by temporally integrating the signal using an integrator (not shown) (step S1202).

The correction amount determination unit 113 converts the angle information into image capturing element information indicating a position of the image capturing element 1000 based on the focal length of the image capturing lens 101 (step S1203). The position of the image capturing element 1000 specified from the image capturing element information is the position of the image capturing element 1000 in a case in which correction is performed by a correction amount, as an ideal value, specified by the correction amount determination unit 113. For this reason, the position of the image capturing element 1000 specified from the image capturing element information is sometimes referred to below as an ideal position of the image capturing element 1000. In addition, a distance in the horizontal direction from the reference position of the image capturing element 1000 to the ideal position is sometimes referred to below as the horizontal ideal distance hs. In addition, a distance in the vertical direction from the reference position of the image capturing element 1000 to the ideal position is sometimes referred to below as the vertical ideal distance vs. In addition, a rotation angle to the ideal position of the image capturing element 1000 is sometimes referred to below as the ideal rotation angle rs.

The correction amount determination unit 113 performs the position determination processing by using the image capturing element information (step S1204). Although details will be described below, in the position determination processing, the final target position of the image capturing element 1000 is determined based on the physically correctable range of the image capturing element 1000, the shutter speed, the electronic vertical distance Mv, and the electronic horizontal distance Mh. The final target position of the image capturing element 1000 is the position of the image capturing element 1000 in a case in which correction by the final correction amount specified by the correction amount determination unit 113 is performed. That is, by the final target position being determined, the correction amount of blur is determined.

The correction amount determination unit 113 outputs target information indicating the determined target position of the image capturing element 1000 to the image capturing element motor drive unit 914 (step S1205).

The correction amount determination unit 113 repeatedly performs the above-described correction amount determination processing for each frame of the video.

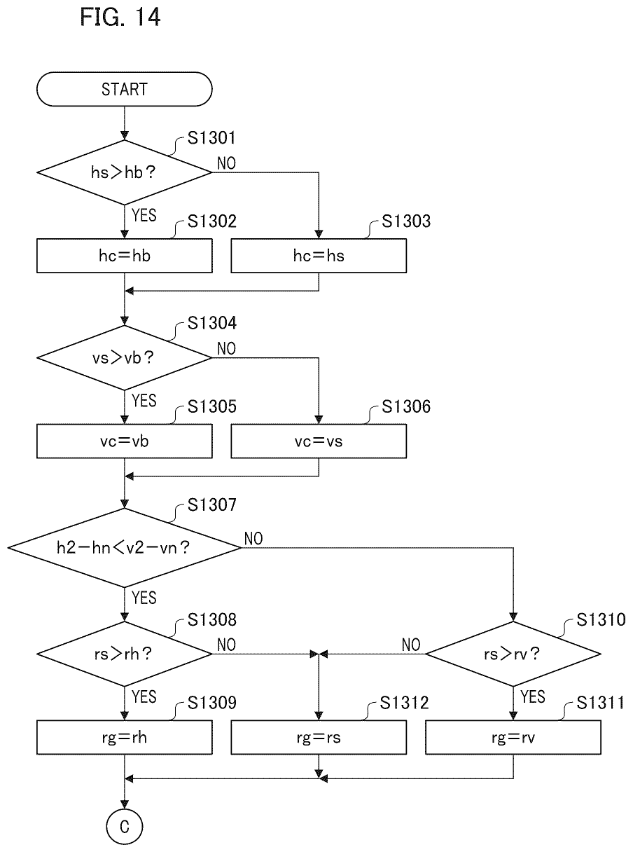

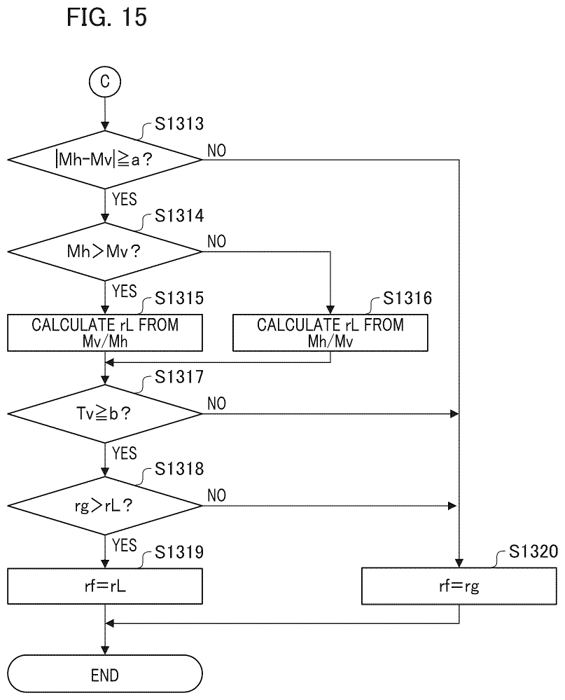

FIG. 14 and FIG. 15 are flowchart diagrams showing a flow of the position determination processing shown in FIG. 13.

The correction amount determination unit 113 determines whether or not the horizontal ideal distance hs is greater than the horizontal possible distance hb (step S1301). The horizontal possible distance hb is a limit distance in the horizontal direction in which the image capturing element 1000 is movable from the reference position based on the current rotation angle of the image capturing element 1000. The horizontal possible distance hb is specified from Equation (7) below.

hb=h1−h1×sin(rt-1−r1+90°) (Equation (7))

In Equation (7), rt-1 is a rotation angle to a final target position determined in the previous position determination processing. The final target position determined in the previous position determination processing is a final target position when position determination processing targeting a frame immediately before a frame that is a target of the position determination processing being executed was performed. In other words, rt-1 is a current rotation angle.

In a case in which the horizontal ideal distance hs is greater than the horizontal possible distance hb (Yes in step S1301), processing proceeds to the next step. The correction amount determination unit 113 determines a target horizontal distance hc, which is a distance in the horizontal direction from the reference position of the image capturing element 1000 to a final target position to which the image capturing element 1000 is to be moved by correction, to be the horizontal possible distance hb (step S1302). That is, the correction amount determination unit 113 restricts the target horizontal distance hc so as not to exceed the horizontal possible distance hb.

In addition, in a case in which the horizontal ideal distance hs is equal to or less than the horizontal possible distance hb (No in step S1301), the correction amount determination unit 113 determines the target horizontal distance hc to be the horizontal ideal distance hs (step S1303).

The correction amount determination unit 113 determines whether or not the vertical ideal distance vs is greater than the vertical possible distance vb (step S1304). The vertical possible distance vb is a limit distance in the vertical direction in which the image capturing element 1000 is movable from the reference position based on the current rotation angle of the image capturing element 1000. The vertical possible distance vb is specified from Equation (8) below.

vb=v1−v1×sin(rt-1−r1+90°) (Equation (8))

In a case in which the vertical ideal distance vs is greater than the vertical possible distance vb (Yes in step S1304), processing proceeds to the next step. The correction amount determination unit 113 determines a target vertical distance vc as a distance in the vertical direction from the reference position of the image capturing element 1000 to a final target position to which the image capturing element 1000 is to be moved by correction, wherein the target vertical distance vc is set to the vertical possible distance vb (step S1305). That is, the correction amount determination unit 113 restricts the target vertical distance vc so as not to exceed the vertical possible distance vb.

In addition, in a case in which the vertical ideal distance vs is equal to or less than the vertical possible distance vb (No in step S1304), the correction amount determination unit 113 determines the target vertical distance vc to be the vertical ideal distance vs (step S1306).

The correction amount determination unit 113 determines whether or not a limit distance in the vertical direction in which the image capturing element 1000 is movable from the current position of the image capturing element 1000 is greater than a limit distance in the horizontal direction in which the image capturing element 1000 is movable from the current position of the image capturing element 1000 (step S1307). The limit distance in the horizontal direction in which the image capturing element 1000 is movable from the current position of the image capturing element 1000 is a value obtained by subtracting a horizontal current distance hn that is a distance in the horizontal direction from the reference position of the image capturing element 1000 to the current position of the image capturing element 1000 from the horizontal upper-limit distance h2. In addition, the limit distance in the vertical direction in which the image capturing element 1000 is movable from the current position of the image capturing element 1000 is a value obtained by subtracting a vertical current distance vn that is a distance in the vertical direction from the reference position of the image capturing element 1000 to the current position of the image capturing element 1000 from the vertical upper-limit distance v2.

In a case in which the limit distance in the vertical direction in which the image capturing element 1000 is movable from the current position of the image capturing element 1000 is greater than the limit distance in the horizontal direction in which the image capturing element 1000 is movable from the current position of the image capturing element 1000 (Yes in step S1307), processing proceeds to the next step. The correction amount determination unit 113 determines whether or not the ideal rotation angle rs is greater than the horizontal possible angle rh (step S1308). The horizontal possible angle rh is a limit angle at which the image capturing element 1000 can rotate from the reference position based on the horizontal current distance hn. The horizontal possible angle rh is specified from Equation (9) below.

rh=sin⁻¹((h2−hn)/h2) (Equation (9))

In a case in which the ideal rotation angle rs is greater than the horizontal possible angle rh (Yes in step S1308), processing proceeds to the next step. The correction amount determination unit 113 determines a target rotation angle rg as a rotation angle from the reference position in a case in which the image capturing element 1000 is to be moved by correction to a target position, wherein the target rotation angle rg is set to the horizontal possible angle rh (step S1309). That is, the correction amount determination unit 113 restricts the target rotation angle rg so as not to exceed the horizontal possible angle rh.

In a case in which the limit distance in the horizontal direction in which the image capturing element 1000 is movable from the current position of the image capturing element 1000 is greater than the limit distance in the vertical direction in which the image capturing element 1000 is movable from the current position of the image capturing element 1000 (No in step S1307), processing proceeds to the next step. The correction amount determination unit 113 determines whether or not the ideal rotation angle rs is greater than the vertical possible angle rv (step S1310). The vertical possible angle rv is a limit angle at which the image capturing element 1000 can rotate from the reference position based on the vertical current distance vn. The vertical possible angle rv is specified from Equation (10) below.

rv=sin⁻¹((v2−vn)/v2) (Equation (10))

In a case in which the ideal rotation angle rs is greater than the vertical possible angle rv (Yes in step S1310), the correction amount determination unit 113 determines the target rotation angle rg to be the vertical possible angle rv (step S1311). That is, the correction amount determination unit 113 restricts the target rotation angle rg so as not to exceed the vertical possible angle rv.

In addition, in a case in which the ideal rotation angle rs is equal to or less than the horizontal possible angle rh (No in step S1308), or in a case in which the ideal rotation angle rs is equal to or less than the vertical possible angle rv (No in step S1310), the correction amount determination unit 113 determines the target rotation angle rg to be the ideal rotation angle rs (step S1312).

The correction amount determination unit 113 determines whether or not the difference between the electronic horizontal distance Mh and the electronic vertical distance Mv is equal to or greater than the restriction threshold value a (step S1313).

In a case in which the difference between the electronic horizontal distance Mh and the electronic vertical distance Mv is equal to or greater than the restriction threshold value (Yes in step S1313), the correction amount determination unit 113 determines whether or not the electronic horizontal distance Mh is greater than the electronic vertical distance Mv (step S1314).

In a case in which the electronic horizontal distance Mh is greater than the electronic vertical distance Mv (Yes in step S1314), the correction amount determination unit 113 calculates a restriction angle rL based on a ratio of the electronic vertical distance Mv to the electronic horizontal distance Mh (step S1315). The restriction angle rL is, as a limit angle at which the image capturing element 1000 can rotate from the reference position, a rotation angle restricted based on a ratio between the electronic horizontal distance Mh and the electronic vertical distance Mv. In step S1315, the restriction angle rL is calculated from Equation (11) below.

rL=Mv/Mh×r1 (Equation (11))

In this case, the restriction angle rL is calculated to be a value less than the upper-limit rotation angle r1.

In a case in which the electronic vertical distance Mv is greater than the electronic horizontal distance Mh (No in step S1314), the correction amount determination unit 113 calculates a restriction angle rL based on a ratio of the electronic horizontal distance Mh to the electronic vertical distance Mv (step S1316). In step S1316, the restriction angle rL is calculated from Equation (12) below.

rL=Mh/Mv×r1 (Equation (12))

In this case, the restriction angle rL is calculated to be a value less than the upper-limit rotation angle r1.

The correction amount determination unit 113 determines whether or not the shutter speed Tv is equal to or greater than the restriction relaxation threshold value b (step S1317).

In a case in which the shutter speed Tv is equal to or greater than the restriction relaxation threshold value b (Yes in step S1317), the correction amount determination unit 113 determines whether or not the target rotation angle rg is greater than the restriction angle rL (step S1318).

In a case in which the target rotation angle rg is greater than the restriction angle rL (Yes in step S1318), processing proceeds to the next step. The correction amount determination unit 113 determines a final angle rf as a rotation angle from the reference position in a case in which the image capturing element 1000 is to be rotated by correction to a final target position, wherein the final angle rf is set to the restriction angle rL (step S1319). That is, the correction amount determination unit 113 restricts the final angle rf to be less than a limit angle at which the image capturing element 1000 can rotate from the reference position based on a current position of the image capturing element 1000 in the horizontal direction and in the vertical direction. In other words, the correction amount determination unit 113 restricts the final angle rf to be less than the target rotation angle rg.

In addition, there is a case in which the difference between the electronic horizontal distance Mh and the electronic vertical distance Mv is less than the restriction threshold value a (No in step S1313), there is a case in which the shutter speed Tv is less than the restriction relaxation threshold value b (No in step S1317), and there is a case in which the target rotation angle rg is equal to or less than the restriction angle rL (No in step S1318). In this case, the correction amount determination unit 113 determines the final angle rf to be the target rotation angle rg (step S1320).

In this manner, in the present embodiment, in a case in which a difference between an electronically correctable amount in the horizontal direction and an electronically correctable amount in the vertical direction is large, correction by rotation of the image capturing element 1000 is restricted. In this case, even in a case in which electronic correction in one direction of the horizontal direction and the vertical direction cannot be sufficiently performed, correction by the shift lens 115 in the one direction becomes less likely to be restricted, and excessive bias in an effect of blur correction between the horizontal direction and the vertical direction is suppressed from occurring.

It should be noted that, although in the position determination processing shown in FIG. 14 and FIG. 15, processing in a case in which the movable end 1001 of the shift-type image capturing element 902 has a rectangular shape was explained, the position determination processing is not limited thereto. The movable end 1001 of the shift-type image capturing element 902 may be another shape in which, in response to movement of the image capturing element 1000 in one direction among movement in the horizontal direction or in the vertical direction, and in a rotation direction, a limit of movement in another direction is restricted (for example, a polygonal shape different from a rectangular shape). In this case, by performing calculation according to the other shape, excessive bias in an effect of blur correction between the horizontal direction and the vertical direction may be suppressed from occurring.

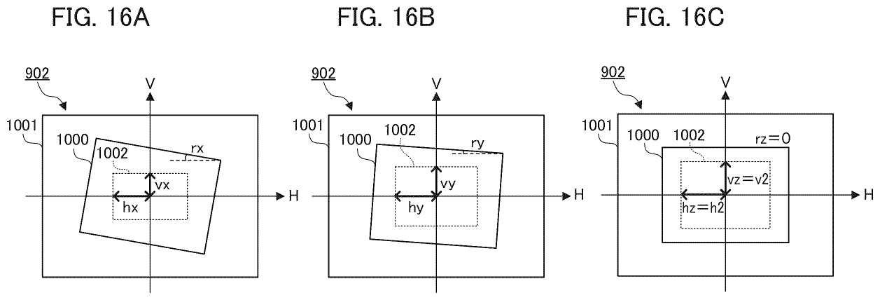

FIGS. 16A and 16C are diagrams showing the movable range of the image capturing element 1000 determined in the position determination processing of the present embodiment. It should be noted that FIGS. 16A and 16C are schematic diagrams of the shift-type image capturing element 902 as viewed from the optical axis direction, similar to FIGS. 11A and 11B. In addition, in FIGS. 16A and 16C, a horizontal axis H indicates the horizontal direction, and a vertical axis V indicates the vertical direction. In FIGS. 16A to 16C, the movable range of the image capturing element 1000 determined in the position determination processing is shown for each template selected as the crop image. More specifically, FIG. 16A shows the movable range of the image capturing element 1000 determined in the position determination processing in a case in which the crop image shown in FIG. 4A is selected as the template. In addition, FIG. 16B shows the movable range of the image capturing element 1000 determined in the position determination processing in a case in which the crop image shown in FIG. 4B is selected as the template. In addition, FIG. 16C shows the movable range of the image capturing element 1000 determined in the position determination processing in a case in which the crop image shown in FIG. 4C is selected as the template.

By using FIGS. 16A and 16C, an explanation is provided with respect to the movable range of the image capturing element 1000 for each template selected as the crop image.

In a case in which, as in the crop image shown in FIG. 4A, a crop image in which a difference between the electronic horizontal distance Mh and the electronic vertical distance Mv is less than the restriction threshold value a is selected as the template, the movable range of the image capturing element 1000 is set based only on the movable end 1001. In this case, a maximum value of a rotation angle of the image capturing element 1000 from the reference position that can be determined in the position determination processing is, as shown in FIG. 16A, the angle rx. In addition, a maximum value of a movement distance of the image capturing element 1000 from the reference position in the horizontal direction that can be determined in the position determination processing is the distance hx. In addition, a maximum value of a movement distance of the image capturing element 1000 from the reference position in the vertical direction that can be determined in the position determination processing is the distance vx.

In addition, in a case in which, as in the crop image shown in FIG. 4B, a crop image in which the electronic vertical distance Mv is greater than the electronic horizontal distance Mh by more than the restriction threshold value a is selected as the template, a rotatable angle of the image capturing element 1000 from the reference position is restricted to be less than the upper-limit rotation angle r1. In this case, a maximum value of a rotation angle of the image capturing element 1000 from the reference position that can be determined in the position determination processing is, as shown in FIG. 16B, the angle ry, the angle ry being less than the angle rx. In addition, a maximum value of a movement distance of the image capturing element 1000 from the reference position in the horizontal direction that can be determined in the position determination processing is the distance hy, the distance hy being greater than the distance hx. In addition, a maximum value of a movement distance of the image capturing element 1000 from the reference position in the vertical direction that can be determined in the position determination processing is the distance vy, the distance vy being greater than the distance vx.

In addition, as in the crop image shown in FIG. 4C, there is a case in which a crop image in which the electronic horizontal distance Mh is greater than the electronic vertical distance Mv by more than the restriction threshold value a and the electronic vertical distance Mv is 0 is selected as the template. In this case, rotation of the image capturing element 1000 from the reference position is restricted. More specifically, a maximum value rc of a rotation angle of the image capturing element 1000 from the reference position that can be determined in the position determination processing is 0. In addition, a maximum value of a movement distance of the image capturing element 1000 from the reference position in the horizontal direction that can be determined in the position determination processing is the distance hz, the distance hz being greater than the distance hy. The distance hz is the horizontal upper-limit distance h2. In addition, a maximum value of a movement distance of the image capturing element 1000 from the reference position in the vertical direction that can be determined in the position determination processing is the distance vz, the distance vz being greater than the distance vy. The distance vz is the vertical upper-limit distance v2.

It should be noted that, although in the present disclosure the correction amount determination unit 113 was explained as determining the horizontal restriction distance hL, the vertical restriction distance vL, and the restriction angle rL by performing calculation, the determination is not limited thereto.

For example, a table in which the horizontal restriction distance hL, the vertical restriction distance vL, and the restriction angle rL are defined for each ratio of the electronic horizontal distance Mh and the electronic vertical distance Mv may be stored in a memory (not shown) of the image capturing apparatus 100. In this context, the correction amount determination unit 113 may determine the horizontal restriction distance hL, the vertical restriction distance vL, and the restriction angle rL by referring to the table.

In addition, although in the present disclosure the correction amount determination unit 113 was explained as restricting a correction amount of the drive target in the position determination processing, a technique for restricting a correction amount of the drive target is not limited to the above-described example.

For example, the correction amount determination unit 113 may decrease a gain of correction amount calculation as a position of the drive target becomes farther from the reference position.

In addition, the correction amount determination unit 113 may restrict a correction amount of the drive target by increasing a cutoff frequency of an HPF (not shown) of correction amount calculation.

In addition, a correction amount of the drive target may be restricted by decreasing a correction ratio of optical blur correction to electronic blur correction.

As described above, in the present disclosure, the shape determination unit 107 determines an aspect ratio of an output region that is output as an image within the image capturing region. An example of the output region is a display region of the crop image. In addition, an explanation was provided that a correction amount of blur, in other words, a movement amount of the drive target from the reference position, is specified from the electronic horizontal distance Mh and the electronic vertical distance Mv. Here, the electronic horizontal distance Mh and the electronic vertical distance Mv are values determined from a relationship between an aspect ratio of the image capturing region and an aspect ratio of the output region. That is, the correction amount determination unit 113 determines a movement amount of the drive target from the reference position based on blur detected by the motion vector detection unit 104, the aspect ratio of the image capturing region, and the aspect ratio of the output region.

In this case, optical correction of a position change of a subject within an angle of view based on a relationship between the image capturing region and a region output as an image is realized.

In addition, the correction amount determination unit 113 determines the movement amount based on a relationship between a difference in size in a vertical direction between the image capturing region and the output region and a difference in size in a horizontal direction between the image capturing region and the output region. The vertical direction may be the vertical direction. In addition, the horizontal direction may be the horizontal direction.

In this case, optical correction of a position change of a subject within an angle of view based on a relationship between a difference in size in the vertical direction between the image capturing region and the output region and a difference in size in the horizontal direction between the image capturing region and the output region is realized.

In addition, the correction amount determination unit 113 determines the movement amount so as to move the drive target within the movable range from the reference position, and the movable range is defined based on the aspect ratio of the image capturing region and the aspect ratio of the output region. Examples of the movable range include a range from the reference position to the horizontal restriction distance hL, a range from the reference position to the vertical restriction distance vL, a range from the reference position to the restriction angle rL, and the like.

In this case, optical correction of a position change of a subject within an angle of view based on a correction range based on the aspect ratio of the image capturing region and the aspect ratio of the output region is realized.

In addition, the movable range is more restricted in a case in which a difference between a difference in size in the vertical direction between the image capturing region and the output region and a difference in size in the horizontal direction between the image capturing region and the output region is equal to or greater than a predetermined threshold value than in a case in which the difference is less than the threshold value. The predetermined threshold value may be the restriction threshold value a.

In this case, compared to a configuration in which the movable range is not restricted regardless of the degree of the difference, occurrence of a difference in a degree to which blur correction is possible between the vertical direction and the horizontal direction is suppressed.

In addition, in a case in which the difference is equal to or greater than the threshold value, the movable range is defined based on a ratio of the difference in size in the vertical direction between the image capturing region and the output region to the difference in size in the horizontal direction between the image capturing region and the output region.

In this case, based on a ratio to a difference in size in the horizontal direction between the image capturing region and the output region, occurrence of a difference in a degree to which blur correction is possible between the vertical direction and the horizontal direction is suppressed.

In addition, in a case in which a difference in size between the image capturing region and the output region in one direction of the vertical direction and the horizontal direction is greater than a difference in size between the image capturing region and the output region in the other direction different from the one direction of the vertical direction and the horizontal direction, the movable range in the one direction is restricted.

In this case, occurrence of a difference in a degree to which blur correction is possible between the vertical direction and the horizontal direction is suppressed.

In addition, the movable range includes a rotatable range of the drive target from the reference position. Examples of the rotatable range include a range from the reference position to the restriction angle rL and the like.

In this case, correction of a position change of a subject within an angle of view based on a correction range based on the aspect ratio of the image capturing region and the aspect ratio of the output region is realized by rotation of the drive target.

In addition, the drive target is a structure in which, as the drive target becomes farther from the reference position in one direction of the vertical direction and the horizontal direction, a movable amount of the drive target from the reference position in the other direction different from the one direction of the vertical direction and the horizontal direction is restricted.

In this case, even in a case in which movement of the drive target in the other direction is restricted by movement of the drive target from the reference position in the one direction, optical correction of a position change of a subject within an angle of view based on a relationship between the image capturing region and a region output as an image is realized.

In addition, the image capturing region is provided larger in the other direction different from one direction of the vertical direction and the horizontal direction than in the one direction of the vertical direction and the horizontal direction, and the output region is provided larger in the one direction than in the other direction.

In this case, even in a case in which electronic correction in the one direction cannot be sufficiently performed compared with the other direction, optical correction of a position change of a subject within an angle of view based on a relationship between the image capturing region and a region output as an image is realized.

In addition, the correction amount determination unit 113 restricts the movement amount more in a case in which the shutter speed is equal to or greater than a predetermined speed than in a case in which the shutter speed is less than the predetermined speed. The predetermined speed may be the restriction relaxation threshold value b.

In this case, even in a case in which the accuracy of optical blur correction is higher than that of electronic blur correction, restriction of optical correction of a position change of a subject within an angle of view is suppressed.

According to the present disclosure, optical correction of a position change of a subject within an angle of view based on a relationship between the image capturing region and a region output as an image can be realized.

### Other Embodiments

The present disclosure can also be realized by processing in which a program that realizes one or more functions of the present embodiment is supplied to the image capturing apparatus 100 via a network or a storage medium, and one or more processors in a computer of the image capturing apparatus 100 read out and execute the program. In addition, the present disclosure can also be realized by a circuit (for example, an ASIC) that realizes one or more functions.

In addition, the present disclosure also includes a case in which a program of software for realizing functions of the above-described embodiments is supplied from a recording medium directly or by using wired/wireless communication to a system or apparatus that comprises a computer capable of executing the program, and the program is executed.

Accordingly, program code itself that is supplied to and installed in the computer in order to realize functional processing of the present disclosure by the computer also realizes the present disclosure. That is, the computer program itself for realizing functional processing of the present disclosure is also included in the present disclosure.

In this case, as long as the program has a function of a program, form of the program does not matter, such as object code, a program executed by an interpreter, script data supplied to an operating system (OS), and the like. Recording media for supplying the program may be, for example, magnetic recording media such as hard disks, magnetic tapes, and the like, optical/magneto-optical storage media, and nonvolatile semiconductor memory.

In addition, as a method for supplying the program, a method is also possible in which a computer program for forming the present disclosure is stored in a server on a computer network, and a client computer that has connected downloads and executes the computer program.

Although embodiments of the present disclosure have been described above, the present disclosure is not limited to the embodiments, and various modifications and changes are possible within a scope of the gist of the present disclosure.

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004678, filed Jan. 14, 2025, which is hereby incorporated by reference herein in its entirety.

What is claimed is:

1. An image capturing apparatus comprising:
at least one memory storing instructions; and
at least one processor configured to execute the stored instructions to:
detect a change in position of a subject within an angle of view;
cause a drive target to move from a reference position using a drive apparatus, thereby controlling an angle of view of an image obtained by using an image capturing element;
determine an aspect ratio of an output region that is output as an image within an image capturing region of the image capturing element;
determine, within the image capturing region, a position of the output region having the determined aspect ratio in accordance with the change; and
determine a movement amount of the drive target from the reference position based on the change, an aspect ratio of the image capturing region, and the aspect ratio of the output region.

2. The image capturing apparatus according to claim 1, wherein executing the stored instructions by the processor further causes the image capturing apparatus to determine the movement amount based on a relationship between (1) a first difference in size in a vertical direction between the image capturing region and the output region and (2) a second difference in size in a horizontal direction between the image capturing region and the output region.

3. The image capturing apparatus according to claim 1,
wherein executing the stored instructions by the processor further causes the image capturing apparatus to determine the movement amount such that the drive target is moved within a movable range from the reference position, and
wherein the movable range is determined based on the aspect ratio of the image capturing region and the aspect ratio of the output region.

4. The image capturing apparatus according to claim 3, wherein the movable range is more restricted in a case in which a difference between (1) a first difference in size in a vertical direction between the image capturing region and the output region and (2) a second difference in size in a horizontal direction between the image capturing region and the output region is equal to or greater than a predetermined threshold value than in a case in which the difference is less than the predetermined threshold value.

5. The image capturing apparatus according to claim 4, wherein the movable range is determined based on a ratio between (1) the first difference in size in the vertical direction between the image capturing region and the output region and (2) the second difference in size in the horizontal direction between the image capturing region and the output region in a case in which the difference between (1) the first difference and (2) the second difference is equal to or greater than the threshold value.

6. The image capturing apparatus according to claim 3,
wherein, in a case in which a difference in size between the image capturing region and the output region in one direction among the vertical direction and the horizontal direction is greater than a difference in size between the image capturing region and the output region in another direction among the vertical direction and the horizontal direction, the other direction being different from the one direction, the movable range in the one direction is restricted.

7. The image capturing apparatus according to claim 3,
wherein the movable range includes a rotatable range of the drive target from the reference position.

8. The image capturing apparatus according to claim 1,
wherein the drive target has a structure in which, as the drive target moves away from the reference position in one direction among the vertical direction and the horizontal direction, a movable amount from the reference position in another direction among the vertical direction and the horizontal direction, the other direction being different from the one direction, is restricted.

9. The image capturing apparatus according to claim 1, wherein the image capturing region is provided larger in another direction among the vertical direction and the horizontal direction, the other direction being different from one direction, than in the one direction, and
the output region is provided larger in the one direction than in the other direction.

10. The image capturing apparatus according to claim 1,
wherein executing the stored instructions by the processor further causes the image capturing apparatus to restrict the movement amount more in a case in which a shutter speed is equal to or greater than a predetermined speed than in a case in which the shutter speed is less than the predetermined speed.

11. A control method of an image capturing apparatus comprising:
detecting a change in position of a subject within an angle of view;
causing a drive target to move from a reference position using a drive apparatus, thereby controlling an angle of view of an image obtained by using an image capturing element;
determining an aspect ratio of an output region that is output as an image within an image capturing region of the image capturing element;
determining, within the image capturing region, a position of the output region having the determined aspect ratio in accordance with the change; and
determining a movement amount of the drive target from the reference position based on the change, an aspect ratio of the image capturing region, and the aspect ratio of the output region.

12. A non-transitory storage medium storing a program for an image capturing apparatus, the program causing a computer to perform each step of a control method of the image capturing apparatus, the method comprising:
detecting a change in position of a subject within an angle of view;
causing a drive target to move from a reference position using a drive apparatus, thereby controlling an angle of view of an image obtained by using an image capturing element;
determining an aspect ratio of an output region that is output as an image within an image capturing region of the image capturing element;
determining, within the image capturing region, a position of the output region having the determined aspect ratio in accordance with the change; and
determining a movement amount of the drive target from the reference position based on the change, an aspect ratio of the image capturing region, and the aspect ratio of the output region.
